(19) United States
(12) Patent Application Publication
(10) Pub. No.: US 2025/0044136 A1
(43) Pub. Date: Feb. 6, 2025

(54) LIQUID DOSING DISPENSER AND LIQUID CONTAINER COMPRISING SAID LIQUID DOSING DISPENSER

(71) Applicant: Smartseal AS, Stavanger (NO)

(72) Inventors: Jeroen Gerrit Anton Gebbink, Helmond (NL); Rune Kristian Knutsen, Stavanger (NO)

(21) Appl. No.: 18/718,273

(22) PCT Filed: Dec. 8, 2022
(86) PCT No.: PCT/EP2022/085053

§ 371 Date: Jun. 10, 2024

(30) Foreign Application Priority Data
Dec. 9, 2021 (NL) 2030093
Mar. 18, 2022 (NL) 2031330

(51) Int. Cl. G01F 11/02

(52) U.S. Cl. CPC G01F 11/028

(57) ABSTRACT

A liquid dosing dispenser is provided, comprising: —a housing defining an internal space comprising a first opening and a second opening; —a dispensing unit; —a first valve arranged in the housing to selectively close and open the first opening; —a closure between the first valve and the dispensing unit for closing/opening a liquid flow though the second opening, the closure comprising a second valve and a base movable in axial direction between a resting position and a compressed position; —a compressible resilient element arranged between the first and second valve; wherein the dispensing unit may move the base of the closure from the resting position to the compressed position upon application of an external actuating force and to urge the closure in axial direction from the compressed to the resting position and the second valve may move with respect to the base to open a third liquid flow passage between the first liquid flow passage and second liquid flow passage when the closure is moved from the resting position to the compressed position.

The present disclosure relates to a liquid dosing dispenser and a liquid container comprising said liquid dosing dispenser.

In the packaging industry there is a need for liquid dispensers, for example dispensers of consumer goods such as soaps and food oils. Liquid dispensers are intended for the controlled release of liquids, for example from containers, in response to a user action. An example of liquid dispensers are liquid pump heads.

Many known liquid dispensers release liquid substantially continuously in response to a user action, produce a volume of liquid through a dispensing system after a varying number of user actions, for example several pump strokes. The volume of liquid which is dispensed is typically inconsistent and unpredictable. For certain applications this may be particularly disadvantageous, for example when the liquid is intended to be mixed after dispensing according to a recipe, when liquid is used in a standardized cleaning protocol, or when the liquid is expensive. For certain applications it may be disadvantageous that multiple pumps are required to release an amount of liquid.

It is a first goal of the present disclosure to provide a liquid dosing dispenser capable of dispensing liquids in a consistent and predictable manner, preferably in a single operation.

A large number of liquid dispensers are used in the packaging industry. Various materials may be used in liquid dispenser components, for example plastics and metals. For example, liquid dispensers may include metal balls to close openings under the influence of gravity, or stainless-steel springs, in addition to plastic components. The use of certain materials increases the cost of manufacturing of components of a dispenser. Various techniques may be required to manufacture and assemble liquid dispensers from their components, for examples gluing or welding components together or snapping components together under significant force. The use of certain materials and techniques complicates manufacturing and assembly and limits the ease with which a dispenser can be manufactured and assembled at a smaller size.

It is a second goal of the present disclosure to provide a liquid dosing dispenser which may be easily, straightforwardly and/or at low cost manufactured and assembled.

Liquid dispensers often have a limited lifespan due to for example contamination with the liquid, spoiling of the liquid, and wear and tear. Furthermore, because of their limited lifespan as well as for other reasons like hygiene protocols, liquid dispensers may be subject to regular replacement schedules. Therefore, the use of liquid dispensers, especially by consumers and in the hospitality industry, results in the generation of relatively much waste.

It is a third aim of the present disclosure to provide a liquid dosing dispenser which may be easily treated as a waste stream, for example by cleaning, recycling, or burning.

The present disclosure achieves at least one of the first aim, the second aim, and the third aim by providing a liquid dosing dispenser, comprising:
a housing defining an internal space comprising a first opening and a second opening, wherein the housing is configured to be attached to a container, such that a first liquid flow passage is formed from the container through the first opening into the internal space;
a dispensing unit configured to be attached to or form an integral part with the housing, such that a second liquid flow passage is formed from the internal space of the housing through the second opening to a dispensing outlet located outside the housing;
a first valve arranged in the internal space and configured to selectively close and open the first opening;
a closure arranged in the internal space between the first valve and the dispensing unit, the closure being configured to selectively close and open a third liquid flow passage extending from the first flow liquid flow passage to the second liquid flow passage, the closure comprising a second valve and a base, wherein at least one of the base and the second valve are movable in axial direction between a resting position and a compressed position;
a compressible resilient element arranged in the internal space between the first valve and the second valve of the closure and configured to urge the at least one of the base and the second valve from the compressed position to the resting position;

wherein the dispensing unit is configured to move the at least one of the base and the second valve from the resting position to the compressed position upon application of an external actuating force on the dispensing unit; and

wherein the second valve of the closure is further configured to be movable with respect to the base, to open the third liquid flow passage when the at least one of the base and the second valve is moved by the dispensing unit from the resting position to the compressed position and/or to close the third liquid flow passage when the at least one of the base and the second valve of the closure is moved by the compressible resilient element from the compressed position to the resting position.

In embodiments of the present disclosure the first valve is configured to close the first opening when the second valve is moved to the resting position and to open the first opening when the second valve is moved to the compressed position.

In embodiments of the present disclosure the first valve is a one-way valve.

In embodiments of the present disclosure the dispenser is further configured to increase the pressure in the internal space of the housing by having the dispensing unit move the base and at least a part of the second valve in axial direction from the resting position towards the compressed position thereby compressing the compressible resilient element and/or to reduce the pressure in the internal space of the housing by having the compressed resilient element move the base and at least a part of the second valve in axial direction from the compressed position towards the resting position.

In embodiments of the present disclosure the dispenser is configured to urge liquid from the internal space of the housing to enter the dispensing unit when the pressure in the internal space of the housing is increased and/or urge liquid from the container to enter the internal space of the housing when the pressure in the internal space of the housing is reduced.

In embodiments of the present disclosure the opening of the third liquid flow passage comprises allowing the pressure increase in the internal space resulting from the movement of the closure from the resting position to the compressed position to move a central portion of the second valve relative to the base from a closed to an open position.

In embodiments of the present disclosure closing the third liquid flow passage between the first liquid flow passage and second liquid flow passage comprises allowing the pressure decrease in the internal space resulting from the movement of the closure from the compressed position to the resting position to move a central portion of the second valve relative to the base from an open position to a closed position.

In embodiments of the present disclosure the dispenser is configured so that the direction of the relative movement of a central portion from the closed position to the open position is opposite the direction of the movement of the base from the resting position to the closed position and/or wherein the direction of the relative movement of a central portion from the open position to the closed position is opposite the direction of the movement of the base from the compressed position to the resting position.

The liquid dosing dispenser according to the present disclosure is comprised such that it may be conveniently manufactured from a limited number of components and from substantially a single material. It may be adapted for use with a variety of liquids and may be embodied in a variety of scales and sizes. It is configured to dispense a consistent and predictable dose at each operating stroke. Because it is made of substantially a single material, it may be disposed of in a convenient and relatively environmentally friendly way.

The present disclosure will be further elaborated according to several exemplifying embodiments, with reference to the following figures.

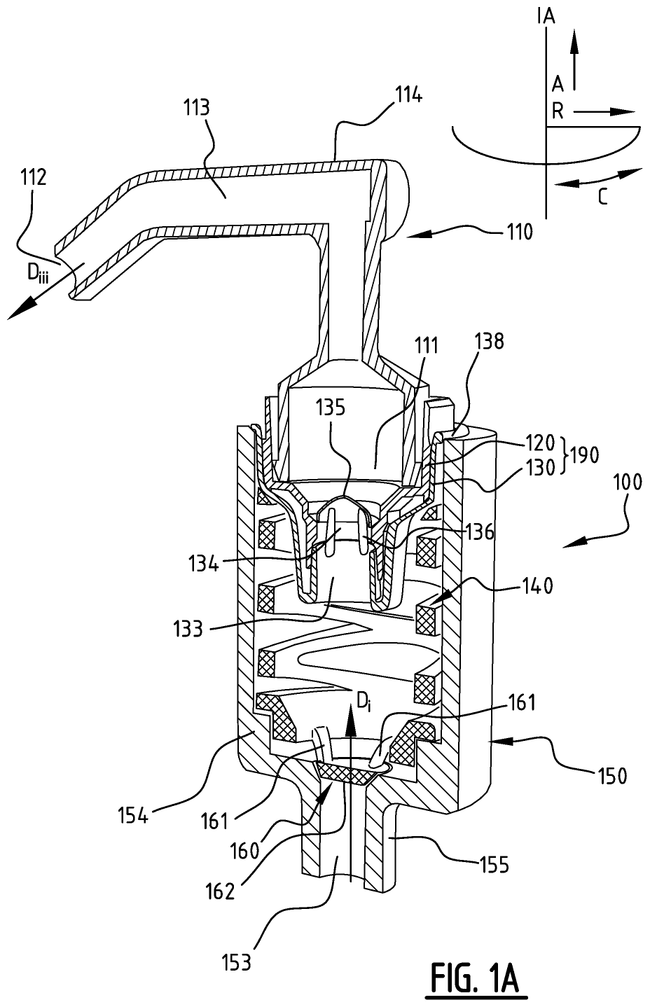

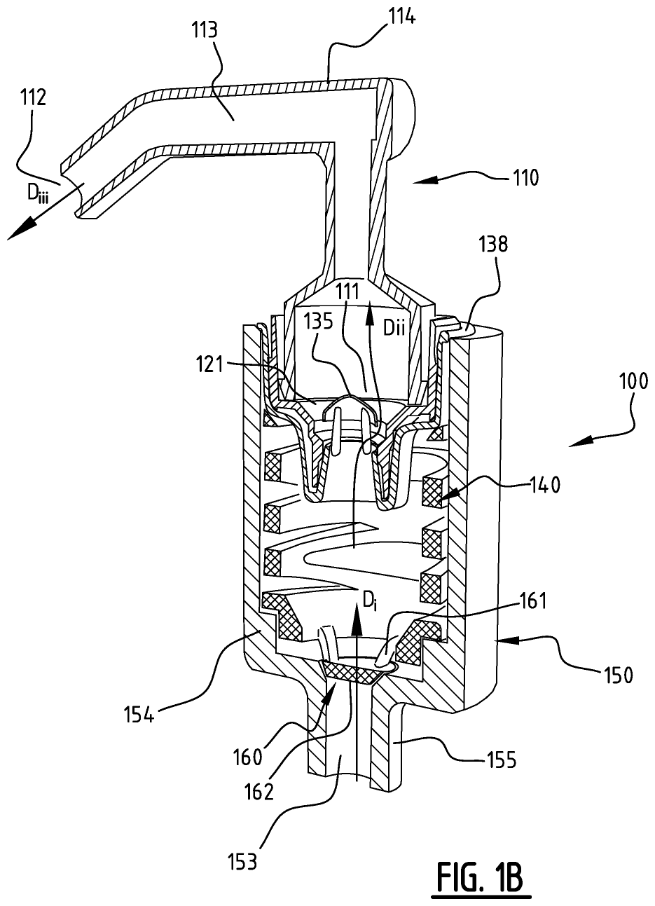

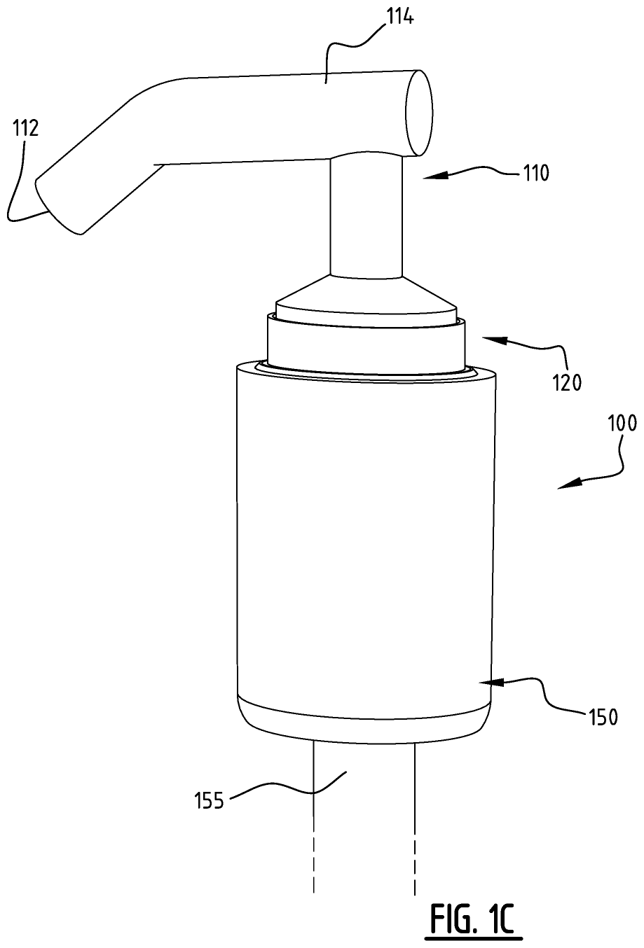

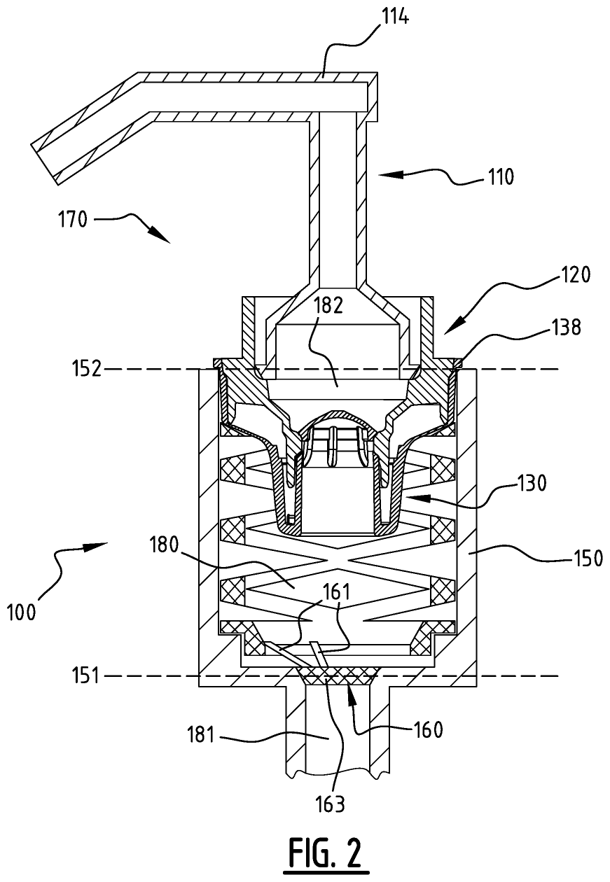

FIGS. 1A-1B and 2 depict cross-sectional views of a first embodiment of a liquid dosing dispenser. FIG. 1C depicts a perspective view of the first embodiment of a liquid dosing dispenser.

FIG. 2 depicts a cross-sectional view of the first embodiment of a liquid dosing dispenser.

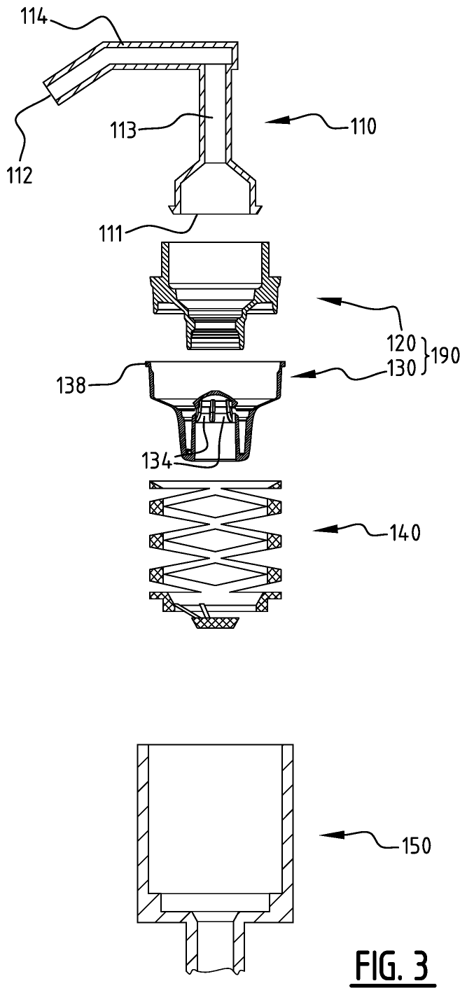

FIG. 3 depicts an exploded view of the first embodiment of a liquid dosing dispenser.

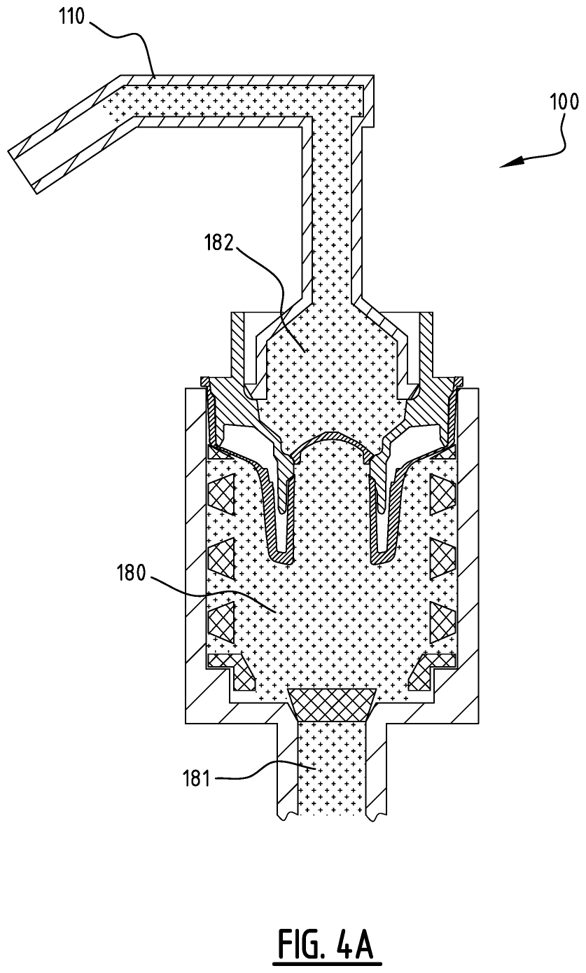

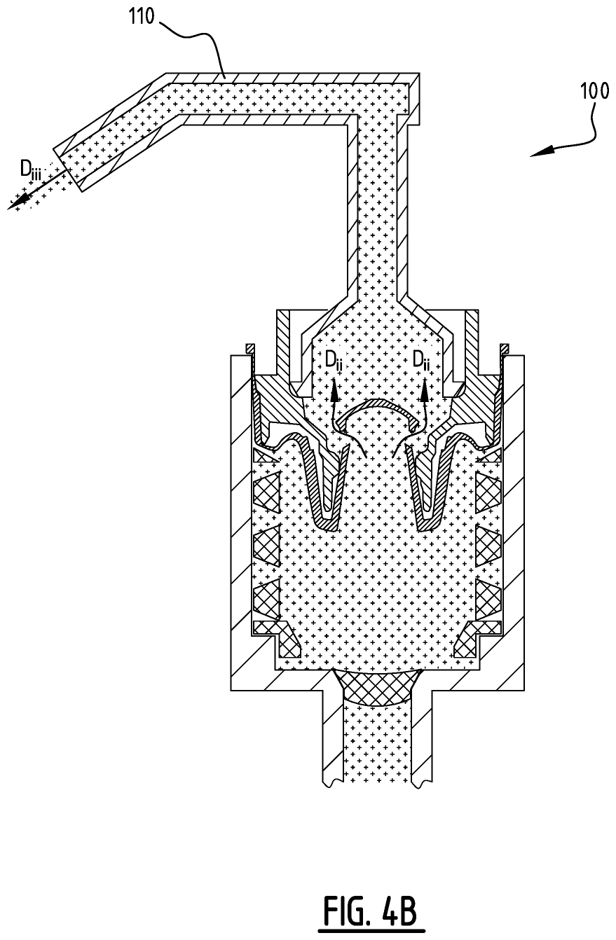

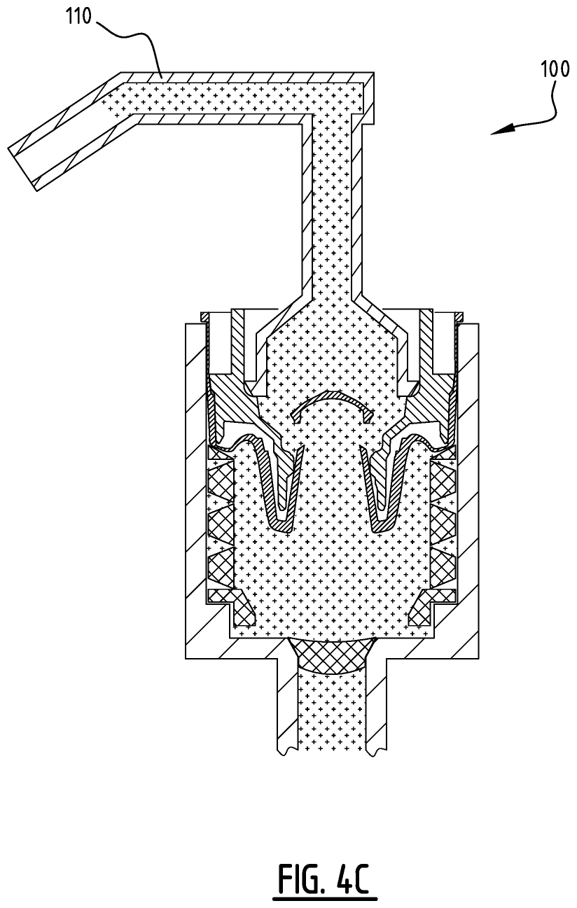

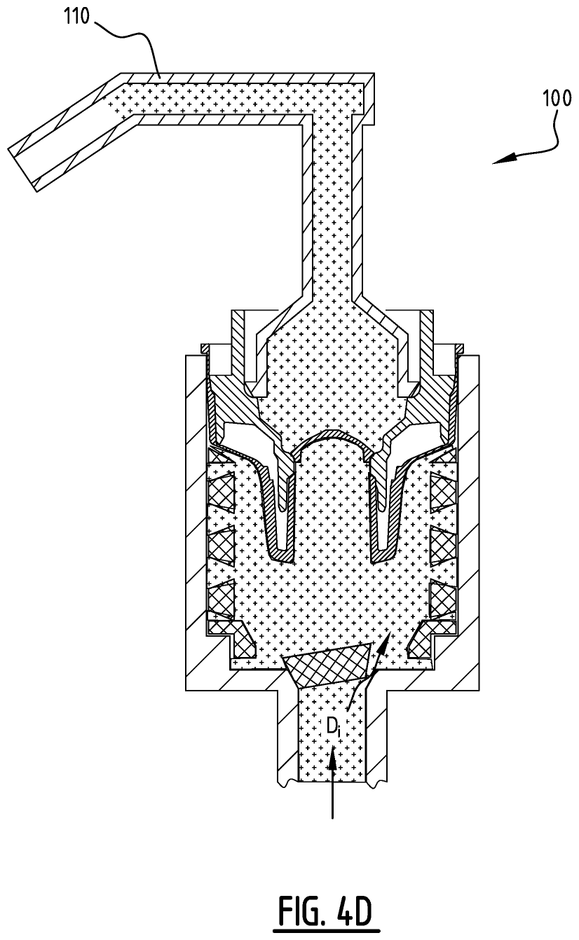

FIGS. 4A-4D depict perspective views of configurations of the first embodiment of a liquid dosing dispenser during operation.

FIG. 5 depicts the outside of a second embodiment of a liquid dosing dispenser.

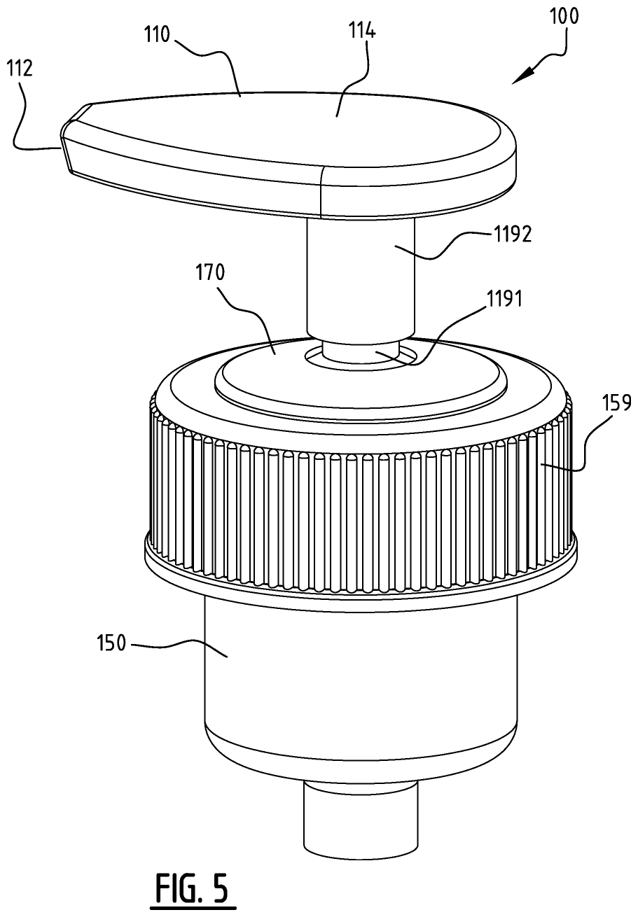

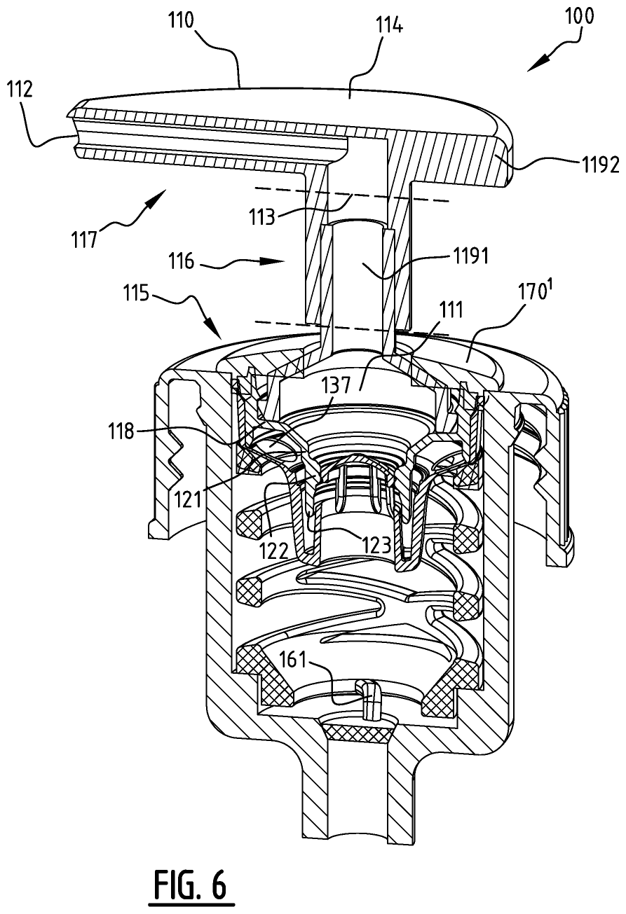

FIG. 6 depicts a cross-sectional view of the second embodiment of a liquid dosing dispenser.

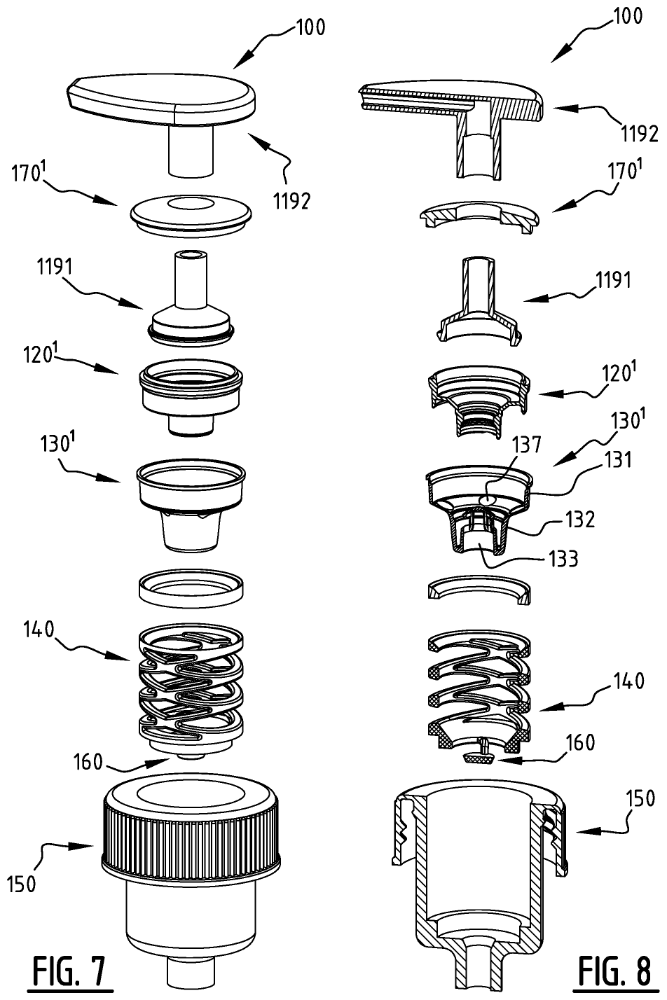

FIGS. 7 and 8 depict exploded views of the second embodiment of a liquid dosing dispenser.

FIGS. 9 and 10 depict perspective views of a second valve according to the second embodiment of a liquid dosing dispenser.

FIG. 11 depicts the outside of a third embodiment of a liquid dosing dispenser.

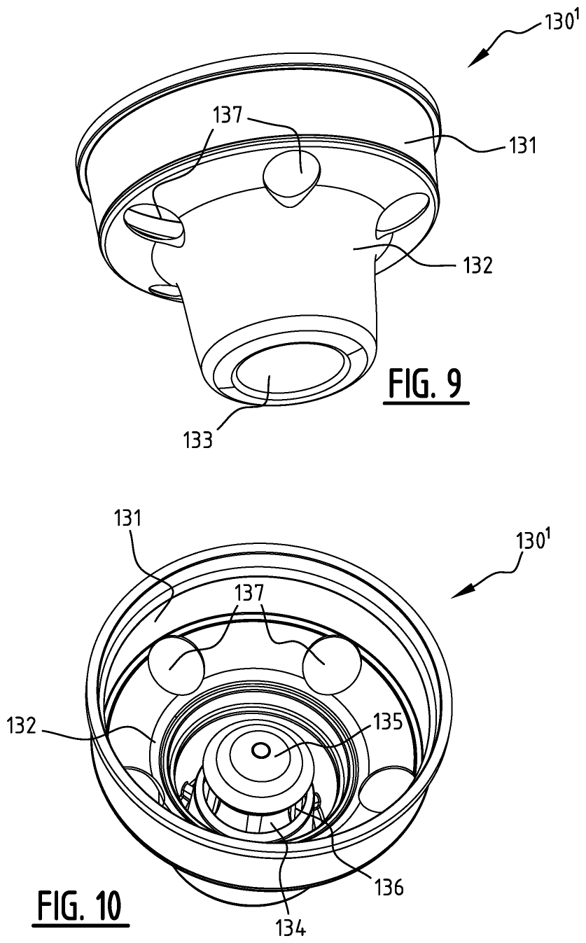

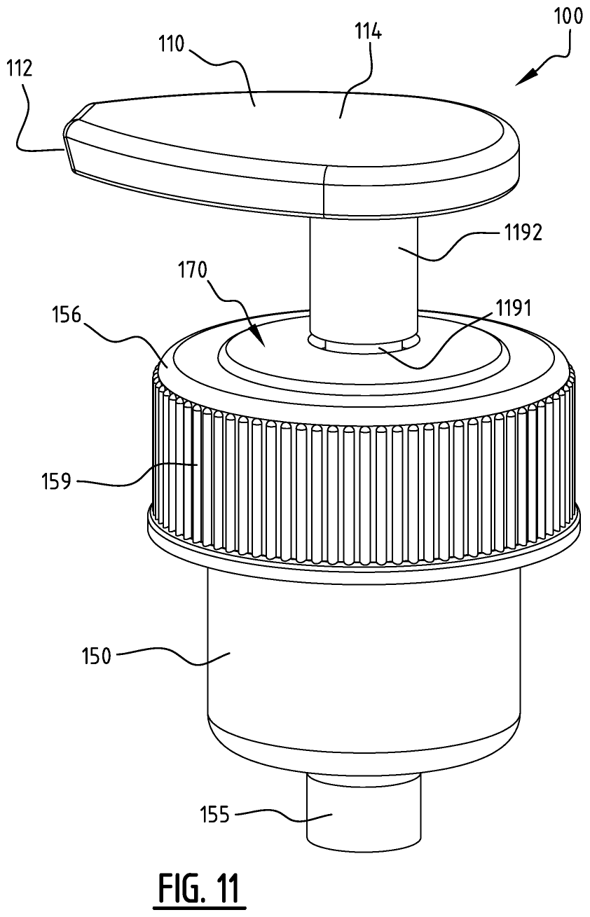

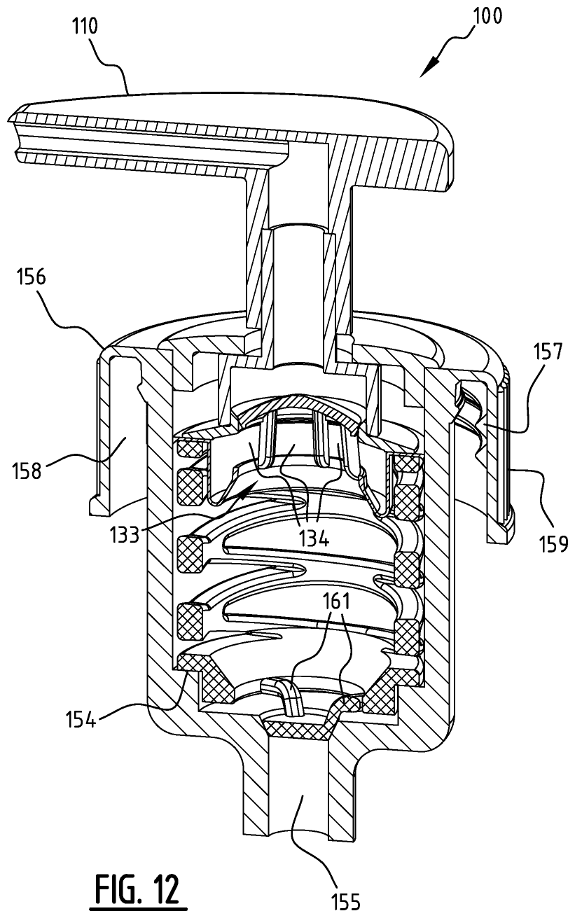

FIG. 12 depicts a cross-sectional view of the third embodiment of a liquid dosing dispenser.

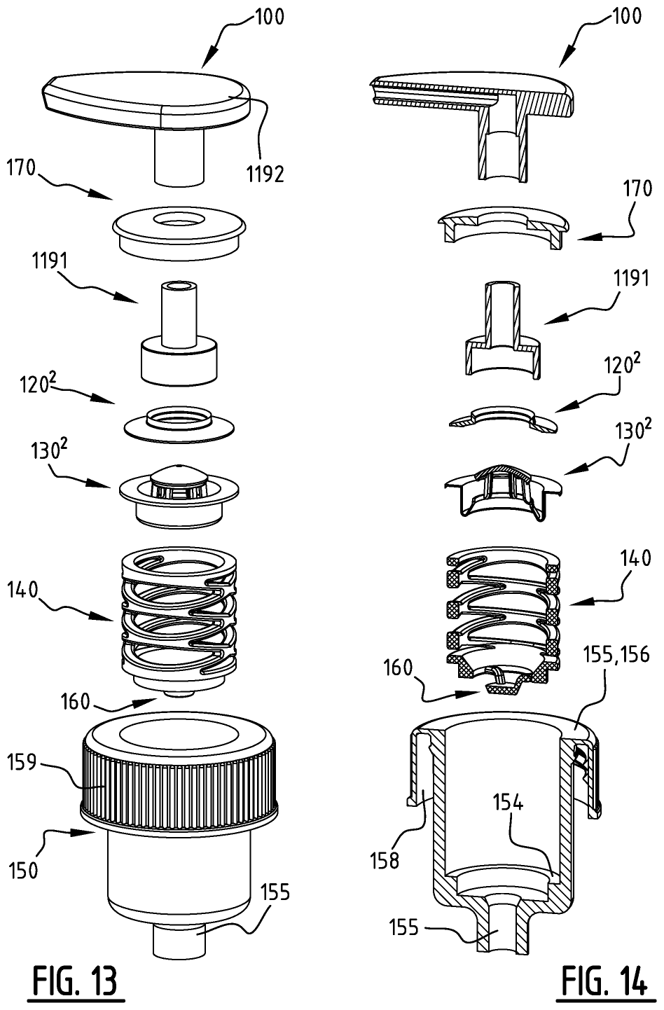

FIGS. 13 and 14 depict exploded views of the third embodiment of a liquid dosing dispenser.

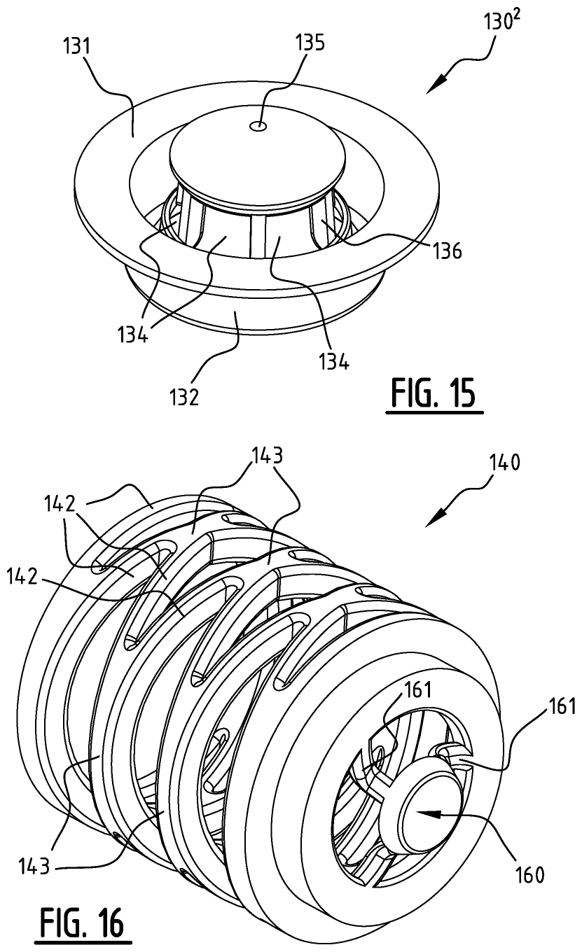

FIG. 15 depicts a perspective view of a second valve according to the third embodiment of a liquid dosing dispenser. FIG. 16 depicts a perspective view of a resilient element and first valve embodied as a single component according to the third embodiment of a liquid dosing dispenser.

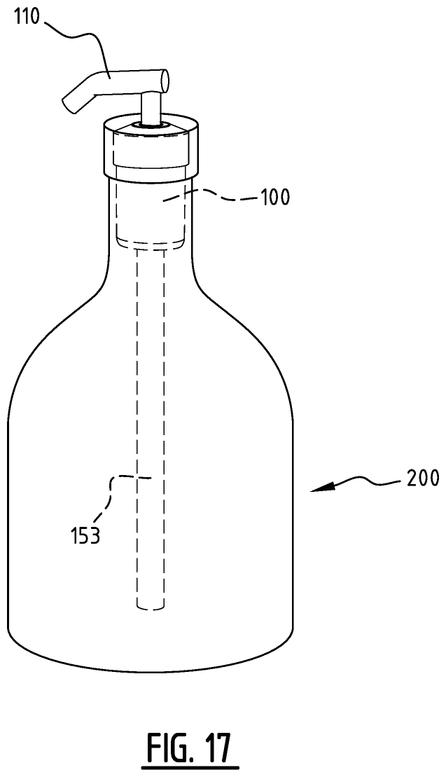

FIG. 17 depicts an embodiment of a container provided with a liquid dosing dispenser.

### GENERAL

In the following description, for the purposes of explanation, numerous specific details are set forth in order to provide a thorough understanding of the present disclosure. It will be apparent, however, that the present disclosure may be practiced without these specific details. In other instances, well-known structures and devices are not described in exhaustive detail, in order to avoid unnecessarily obscuring the present disclosure.

It is noted that, as used herein and in the appended claims, the singular forms “a”, “an” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

### DESCRIPTION OF EXEMPLIFYING EMBODIMENTS

In the following description when reference is made to the concept of a “liquid container”, one may consider any type of holder for holding content, for instance a bottle for liquid such as soap or oil. However, the liquid dosing dispenser as described herein is not restricted to application to this specific type of liquid container. In fact, the dispenser as defined herein may also be applied to any other type of container, such as—but not limited to liquid jars, flasks, kegs, cartons, pouches, etc. A container may also be an object or system which holds liquid while it is not designed for that purpose, for example a naturally occurring source of liquid.

An example of a liquid container is shown in FIG. 17. The figure shows liquid container 200 in the form of a bottle having one outlet opening at its upper end. A liquid dosing dispenser 100 is mounted at this upper end of the liquid container 200 and is configured to selectively dispense dosed quantities of liquid from the interior of the liquid container 200 through the outlet opening to the environment exterior to the liquid container 200. Dispensing the dosed quantity of liquid may be accomplished by (for instance manually) operating a dispensing unit 110 of the liquid dosing dispenser 100, as will be explained later.

Embodiments of 1 liquid dosing dispenser 100 are shown, for instance, in FIGS. 1-4, 6-9, and 11-14. More specifically, FIGS. 1-4 show various perspectives of a first embodiment of a liquid dosing container 100, FIGS. 6-9 depict various perspectives of a second embodiment of a liquid dosing container 100, and FIGS. 11-14 depict various perspectives of a third embodiment of a liquid dosing container 100. The following description is generally applicable to each embodiment. Where the description refers to features of specific embodiments, this will be indicated. The depicted embodiments are exemplary, and other embodiments are possible within the scope of the claims. Features of specific embodiments which are not described as alternatives can generally be combined in the same embodiment.

Referring to FIGS. 1-4, 6-9, and 11-14, and 17, a liquid dosing dispenser 100 is configured to take liquid from a first location within the container 200 and to discharge or dispense the taken liquid out of the container to a second location outside the container. The liquid is dispensed in a set of consecutive doses. The liquid dosing dispenser 100 may be advantageously operated in a professional food service or medical environment, but application in other environments also benefits from the advantages as set forth herein, for example in a home kitchen or bathroom or in a workshop.

The liquid dispenser 100 may advantageously be manufactured from one or more plastic materials, for example polypropylene(s) (PE), polyurethane(s) (PU/PUR), polyphenyl ether(s) (PPE), or polyphenylene oxide (blends) (PPO). Preferably the components of the liquid dosing dispenser 100 are all made of the same material (i.e., the liquid dosing dispenser 100 is a mono-material liquid dosing dispenser). In other embodiments the liquid dosing dispenser 100 is made of only a few (for instance two) different materials which are closely related materials and may be treated as belonging to a same class of materials for purposes of manufacturing and/or disposal (for instance, when the liquid dosing dispenser is disposed of and becomes waste material). In especially beneficial embodiments all components of the liquid dosing dispenser 100 are made of polypropylene. In this case, valves (that is, the first valve 160 and/or the second valve 130 of the closure 190, discussed below) may be made of low-density polypropylene (LDPE) (or of polyphenyl ether), while all other components of the liquid dosing dispenser 10 are made of high-density polypropylene (HDPE). In another example, all components of the liquid dosing dispenser 100 may be made of polyurethane.

The components of the liquid dosing dispenser 100 may be manufactured by any plastics manufacturing or shaping techniques. Advantageously, substantially all components are manufactured using injection molding, although alternatively or additionally other techniques like extrusion, 3D-printing, or subtractive processes like machining under computer numerical control (CNC) could be used as well.

The figures show different embodiments of a liquid dosing dispenser 100. In each of the embodiments the liquid dosing dispenser 100 comprises a housing 150 (which may be a generally cylindrical housing), having a first (lower) opening 151 at its container end a second (upper) opening 152 at its dispensing end), a first valve 160 arranged near the second opening 152, a closure 190 arranged near the first opening 151 (the closure 190 comprising a second valve 130 and base 120 axially movable in the housing 150), a resilient element 140 such as a conical spring acting on at least the base of the closure 190), a dispensing unit 110 removably connected to the housing 150 and/or to the closure 190 and configured to actuate (i.e. opening and closing) the closure 190 and to guide a flow of liquid to a dispensing outlet 112 for dispensing or discharging liquid in dosed quantities from the housing 150 to the environment. In at least the second and third embodiments the liquid dosing dispenser 100 may further comprise a(n) (optional) housing cover 170, 170′. The housing 150 defines an internal volume (also referred to as the internal space 180) delimited by the inner surface of the housing 150, the first valve 160 and the first valve of the closure 190. The internal volume/space 180 is open at opposing sides, via the first opening 151 and the second opening 152. Because the operation of the liquid dosing dispenser 100 depends on pressure levels in the internal space 180, the internal space 180 has no further openings or at least no further openings that cannot be sealed off.

Referring to FIG. 1A, a longitudinal imaginary axis IA may be defined between the first opening 151 and the second opening 152, relative to which an axial direction A, a radial direction R and a circumferential direction C may be defined. In the axial direction, an inner side toward the container 200 and an outer side may be distinguished. It is noted that the housing 150 as well as the other components of the dispenser 100, possibly apart from the dispensing unit 110, are preferably substantially radially symmetric around this axis IA. This is to make the design of the liquid dosing dispenser 100 as simple as possible, although this is not necessary to achieve at least some of the advantages of the present disclosure.

By way of example, the liquid dosing dispenser 100 may be placed on top of a liquid container 200, in which case the imaginary axis IA may be substantially vertical, with the first opening 151 located at the bottom side of the housing 150 and the second opening 152 located at the top side of the housing 150. This is the orientation in which the components are drawn in the figures. However, because the operation of the liquid dosing dispenser 100 is not fundamentally dependent on gravity, it is not necessary to place and/or operate the liquid dosing dispenser 100 in a particular orientation to be able to achieve the advantages of the disclosure. For instance, the first opening 151 could be located at a higher position than the second opening 152. However, it may be necessary, under certain conditions, to adapt the dimensions and materials of the components of the liquid dosing dispenser 100 to account for the influences of gravity on the components and/or on the liquid in a container, which arise from placing and/or operating a particular embodiment of the liquid dosing dispenser 100 in a particular orientation, for example by adjusting the stiffness or surface area of components or of portions of components.

As mentioned above, the liquid dosing dispenser 100 comprises a housing 150 and, optionally, a housing cover 170. For more detail, reference is made to FIGS. 2, 11-14. The internal volume or space 180 of the housing 150 is configured to be connected via its first opening 151 with the earlier-mentioned liquid container 200. The housing 150 may be fixedly connected to this liquid container 200 and may even be integrally formed with the liquid container 200 (i.e., manufactured in one piece with the liquid container 200). Alternatively, the liquid dosing dispenser 100 may comprise connecting means, for example screw thread 157 as depicted in FIGS. 6 and 12, allowing the housing 150 of the liquid dosing dispenser 100 to be removably connected to the liquid container 200.

The first opening 151 of the housing 150 is dimensioned to fit the opening of a particular size and type of liquid container 200. In the shown embodiments the housing 150 is provided at the earlier-mentioned container (axially inside) end with an axially extending inlet portion 155 connecting to the first opening 151. This cylindrical extending inlet portion 155 may be cylindrical and may be positioned concentrically with the cylindrical housing 150 or may be positioned at an eccentric position. In certain embodiments the inlet portion 155 is provided with a pipe 153. The pipe 153 may be rigid or may be at least partially flexible (cf. FIG. 17). In the depicted embodiment, the diameter of the first opening 151 is substantially smaller (in the radial direction (R)) than the diameter of the internal space 180. This may aid the operation of the first valve 160 (to be described below) by making it easier to close the first opening 151, but it is not necessary for achieving at least one of the advantages mentioned herein.

In connected condition and in absence of the other components of the dispenser 100, the internal space 180 of the housing 150 is configured to be open to an operating environment via its second opening 152. This operating environment may be a human working or living environment, or may be a device, for example a liquid reservoir or transport system. In the shown embodiments the second opening 152 is substantially equal in diameter in the radial direction to the diameter of the internal space 180. This may aid in assembly of the components and/or it may help in the operation of the first valve 120, 130 (to be described below) by providing space for a larger surface area of the second valve 130, but it is not necessary for achieving at least one of the advantages of the present disclosure.

When the housing 150 is viewed separately from the other components of the dispenser 100, the internal space 180 of the housing 150 may be understood to stretch from a plane across the first opening 151 to a plane across the second opening 152. However, in operation, the effective shape and size of the internal space 180 in any one configuration will be determined by the shape and axial size of the first valve 160 and closure 190. In operation it is relevant that the internal space 180 has a predetermined size in both a resting state (also referred to as the resting position or initial position) and a compressed state (also referred to as the compressed position), or at least a predetermined size difference between the two states, in order to generate the forces needed to displace a predetermined liquid dose towards the dispensing unit 110 when the dispensing unit 110 of the liquid dosing dispenser 100 is moved from the resting state to the compressed state and vice versa.

The housing 150 of the dispenser should close off the internal space 180 at all sides from the environment, except for the earlier mentioned first opening 151 and second opening 152. At the side of the second opening 152, a passage should be formed to enable liquid flow, but at the same time, the closure 190 and the resilient element 140 should be prevented from exiting the internal space 180 during operation, particularly during an upstroke. In the resting state, the expansion of the resilient element 140 should preferably be limited to a maximum extent by an end stop cooperating with a supporting portion 154 at the other end of the internal space 180. The liquid dosing dispenser 100 may comprise a housing cover 170 to accomplish one or more of these goals.

The (optional) housing cover 170 may further serve to shield portions of the dispensing unit 110 and of the closure 190, that is, of the second valve 130 and base 120, from the environment. This may have advantages in reducing contamination, reducing wear, and/or of reducing deformation and/or movement of the components in undesirable directions, which may damage the dispenser or reduce the effectiveness of its operation.

During manufacturing of the dispenser 100, after the components to be arranged in the internal space 180 have been assembled into the housing 150, the housing cover 170 may be arranged on the housing 150 and may be fixedly connected to the outside of the housing 150 by means of glue or by a mechanical connection, for example a screw thread connection (not depicted).

The housing 150 may comprise connecting portions 156, for example a cap provided with internal screw thread 157. As can be seen in FIGS. 6 and 12 for the second and third embodiments respectively, this cap may first extend radially outward from the axially outward side of the rest of the housing 150 near the second opening, and then axially inward. This way it may define a generally ring-shaped cavity 158 in which screw thread 157 may be provided on a radially inside or outside wall to connect the liquid dosing dispenser 100 to corresponding screw thread of a container 200. Different types of connecting portions 156, such as one half of a connection to be snapped together, may be provided instead. The connecting portions 156 may be adapted to fit standard container types and sizes.

The housing 150, especially a connecting portion 156 of the housing 150, may be provided at its outside with ridges, irregular patches, or other gripping portions 159 to allow a user such as a person or device to grip the liquid dosing dispenser 100 more easily.

### First Valve

As mentioned above, the liquid dosing dispenser 100 comprises a first valve 160. The first valve 160, which may also be referred to as (valve) flap or stopper, essentially is a one-way valve. The one-way valve is preferably configured to allow liquid from the container 200 to flow into the internal space 180 while essentially preventing or at least impeding liquid to flow from the internal space 180 back into the container 200. The first valve 160 is positioned in the housing 150 between the container 200 and the internal space 180 to selectively close off and open the first opening 151. In the shown embodiments the first valve 160 comprises a thin flexible sheet 162 connected via a number of connection rods 161 to the stationary bottom end of a resilient element 140. The thin flexible sheet 162 thus connected may be caused to move and/or deform in response to differences between the pressure inside the liquid container 200 and the pressure inside the internal space 180. When the pressure inside the liquid container 200 is higher than the pressure inside the internal space 180 (for instance, when the dispensing unit 110 is moved from the compressed position to the resting position under the influence of the resilient element 140 thereby creating an underpressure inside the internal space 180), the first valve 160 is opened so that liquid my flow from the container 200 to the internal space 180 of the liquid dosing dispenser 100, whereas the liquid will be prevented from flowing in opposite direction from the internal space 180 (back) into the liquid container 200 when the pressure inside the liquid container 200 is lower than the pressure inside the internal space 180 (for instance, when the dispensing unit 110 is in its initial or resting position or if the dispensing unit 110 is moved from the resting position to the compressed position, against the spring action of the resilient element 140). In this manner the first valve 160 may act as a one-way valve only allowing liquid flow in axial direction towards the housing of the liquid dosing dispenser 100.

More specifically, the first valve 160 may be configured and arranged to cover the first opening 151 when no liquid flow from the container 200 to the internal space 180 is present, extending over substantially the whole first opening 151. In that case, when liquid flow from the container 200 to the internal space 180 is present, for example when pressure in the internal space 180 is lowered because of the device performing an upstroke (to be discussed later), the first valve 160 may move or deform, allowing liquid flow through the first opening 151.

Material properties and geometrical dimensions of the first valve 160 may be varied to adapt the liquid dosing dispenser 100 for use with different types of liquid. For example, in case of the use of a particularly viscous liquid, it may be advantageous to increase the stiffness of the first valve 160 to account for the slower flow of the liquid and to prevent the first valve 160 from remaining in an open and non-covering position for too long. When the liquid dosing dispenser is to be used for dispensing a less viscous (more easily flowable) liquid, the stiffness of the first valve 160 may be reduced.

As mentioned above, the first valve 160 preferably provides some resistance to liquid flow from the internal space 180 to the container 200 through the first opening 151, i.e., at least in the resting state, to keep liquid from leaving the internal space 180 in an undesirable direction. This is at least required when the liquid dosing dispenser 100 is used in the depicted orientation in view of the effect of gravity on liquid in the internal space 180.

In response to a certain level of liquid pressure from inside the internal space 180 and/or to forces acting on it from the resilient element 140, the first valve 160 may deform and/or at least partially move into the first opening 151 to substantially completely close the first opening 151 to liquid flow from the internal space 180 toward the container 200. Thereby the first valve may contribute to a (further) rise of the liquid pressure inside the internal space 180.

### Closure—Base and Second Valve

The liquid dosing dispenser 100 further comprises a closure 190 comprising a second valve 130 (i.e., a second valve 130 according to a first embodiment, a second valve 130¹ according to a second embodiment and a second valve 130² according to a third embodiment) and a base 120 (again a base 120 according to a first embodiment, a base 120¹ according to a second embodiment and a base 120² according to a third embodiment). The closure 190 is arranged in the housing 150, more specifically in the internal space 180 of the housing 150, to selectively close and open the second opening 152 leading to the dispensing outlet 112. The closure 190 comprises a second valve 130 and base 120, and preferably no other elements. The second valve 130 is made at least partially of flexible material (i.e., more flexible than the material of the base 120). The flexible material makes it possible to allow the second valve 130 to deform in operation under liquid pressure and/or under the influence of forces from other elements or components from an initial state to a deformed state and to automatically return from the deformed state to the initial state when the pressure and/or or forces are removed. Generally, as mentioned above, the base 120 is made of more rigid material than the material of the second valve 130. The base 120 may rigid enough so that it essentially does not deform in operation and that it may cause the material of the second valve 130 to deform. For more detail about various embodiments of the second valve 130, reference is made to the figures, in particular to FIGS. 1-4 for the first embodiment, FIGS. 6-10 for the second embodiment and FIGS. 12-15 for the third embodiment.

In the first, second and third embodiments the second valves 130, 130¹, 130² are configured to completely seal off the second opening 152 of the housing except from the one or more radial openings/holes 134 provided in a central part of the second valve. In other words, the only way any liquid may pass from the internal volume or space 180 through the second opening 152 towards the dispensing outlet 112 of the dispensing unit 110 is via these one or more radial openings/holes 134 (i.e., only in the opened position of course). Furthermore, the second valve 130, 130¹, 130² is firmly attached to the housing 150. In the embodiments shown the upper end of the second valve 130, 130¹, 130² may form a circumferential seal 138 that is mounted to the housing 150, thereby forming a liquid tight seal between the valve and the housing and preventing the leakage of any liquid from the internal volume/space 180 through the connection between the second valve 130 and the housing. In other embodiments the second valve 130 may be connected directly to the inner surface of the housing, for instance by gluing or the like, or may be firmly pushed against the inner surface of the housing by a ring-shaped pushing element (not shown) so as to keep the second valve locally in place during operation of the liquid dosing dispenser 100.

In each of the first, second and third embodiments, the second valve 130, 130¹, 130² comprises a central portion 133 extending in an axial direction from the internal space 180 towards the dispensing unit 110. The central portion 133 and the base are movable relative to each other so that radial holes 134 in the central portion 133 may positioned in an open position wherein the radial holes 134 are not obstructed by the base 120, 120¹, 120² and therefore the liquid in the internal space 180 is allowed to flow towards the dispensing unit and a closed position wherein the radial holes 134 are obstructed by the base 120, 120¹, 120² and therefore the internal space 180 is fully sealed off from the dispensing unit. The relative movement of the central portion 133 and the base 120, 120¹, 120² may be caused by manually pushing the dispensing unit 110 into the internal space 180 in the housing 150, which tends to reduce the volume of the internal space 180. Due to the incompressibility of the liquid inside the internal space 180, the central portion 133 then is pushed from the closed position to the open position. Note that the relative movement of the central portion 133 with respect to the base does not mean that the central portion is necessarily moved: in some embodiments of the present disclosure and under specific circumstances the base is moved relative to the housing 150 while the central portion 133 of the valve remains in place. In other embodiments, the central portion will in fact be caused to move relative to the housing, for instance in an axially outward direction (or in an axially inward direction, in the latter case the base is moved over a longer distance than the central portion).

In the following, more details about the first, second and third embodiments are discussed. In the first and second embodiments, the respective second valve 130, 130¹ and base 120, 120¹ is configured to be arranged such that the radially outer portion 131 (which radially outer portion 131 extends more or less in the axial direction) of the second valve is located in between the inner surface of the housing 150 and the base 120. The radial outer portion 131 may radially surround the relevant part of the base entirely. In the third embodiment the second valve 130² (cf. FIG. 12) and the associated base 130² have a simpler design in that an outer portion extending in a generally axial direction and a base arranged to be slid along the inner surface of this outer portion (as will be explained hereafter) are dispensed with.

Reference is made to FIG. 15 wherein the second valve 130² is shown in more detail. The second valve 130 may be substantially radially symmetric around the imaginary axis IA of the dispenser. A radially outer portion 131 of the second valve 130 is positioned against the inside of the housing 150, an intermediate portion 132 first extends radially and axially inward into the internal space 180. The central portion 133 of the second valve 130 forms an axially outer protrusion comprising one or more holes 134, for example a plurality of radially arranged holes, preferably substantially equally distributed around the outward protrusion. The radial holes 134 are formed between a plurality of connecting elements 136 connecting a first part of valve 130² with a second, dome-shaped part 135 of the valve 130².

As mentioned above, the central portion 133 of each of the embodiments of the second valve 130, 130¹, 130² are configured to be moved and/or deformed by pressure from liquid inside the internal space 180. The central portion 133 then may move axially outward to move its radial openings or radial holes 134 axially outside the base 120, 120¹, 120² to open the closure 190. The second valve 130, 130¹, 130² further preferably has such material properties that, insofar as it has previously been deformed by pressure from the base, from liquid in the internal space 180 or forces from other components, it automatically deforms back into a resting shape when the pressure or force is removed (the resting shape essentially corresponding to the initial state). To this end, it is advantageous if the surface area of the portion 155 is generally dome-shaped. It is also advantageous if the cross-sectional area of the central portion 133, more specifically the cross-sectional area of the dome-shaped portion 135 is large in comparison to the area of the second opening 152 (i.e., it covers a relatively large part of the second opening 152) and that the cross-sectional area of the dome-shaped portion 135 is small in comparison to the area of the first opening 111 and/or the fluid passage 113 of the dispensing unit 110. The configuration of the third embodiment is particularly advantageous in this regard.

In each of the embodiments the base 120, 120¹, 120² is connected to or integrally formed with the dispensing unit 110. When the dispensing unit 110 is moved into the housing, for instance manually depressed (i.e., moved in axial direction into the internal space 180 of the housing 150), the base 120, 120¹, 120² moves along in the same direction. Similarly, when the base 120, 120¹, 120² is moved in an opposite direction, i.e., an axial direction out of the housing, under the influence of the spring force generated by the compressed resilient element 140, the dispensing unit 110 is moving along with the base 120, 120¹, 120².

Furthermore, the base 120, 120¹, 120² in each of the first, second and third embodiment may at least partially made of rigid material and/or may be made rigid by selecting a suitable shape. The rigidness should be sufficient to be able to move and/or deform at least a part of the associated second valve 130, 130¹, 130². On the one hand the sealing function of the second valve with respect to the housing is maintained and on the other hand the central portion of the second valve is enabled to be selectively moved from the closed to the open position or from the open to the closed position to respectively open or close the passage of liquid from the internal space 180 to the dispensing outlet 112. In some embodiments the base 120, 120¹ has a cylindrical axial portion that is configured to slide from the resting position to the compressed position along the earlier mentioned radially outer portion 131 of the second valve 130, 130¹ extending more or less in the axial direction of the housing when an external force is exerted on the dispensing unit 110 and therefore on the base), thereby deforming the second valve while the circumferential seal 138 maintains its sealing function. In other embodiments the base 120² is configured to apply a pushing force on the second valve 130², thereby moving the second valve axially more into the internal space 180, from a resting position to a compressed position. In both situations the pressure inside the internal space 180 increases (since the deformation resp. movement causes a reduction of the volume of the internal space 180 and the first valve 160 closes the first opening 181), which increased pressure in turns causes the movable central portion 133 of the second valve 130 to move (so as to increase the volume again or at least keep the volume constant) so that the closure 190 comprising the second valve 130 is brought from the closed to the open position. Conversely, when the external force is removed or at least sufficiently reduced, the action of the resilient element 140 causes the second valve 130 and base 120 to return from the compressed position to the resting position. This causes the volume of the internal space 180 to increase again, thereby reducing the pressure inside the internal space 180. This reduction of the pressure causes (1) the first valve 160 to open the first opening 181 and to allow additional liquid to enter the housing 150 and (2) the central portion 133 of the second valve to return from the open position to the closed position (in some embodiments assisted by the spring action of the flexible part(s) of the second valve 130 urging a deformed second valve 130 to return to its original position).

Each of the embodiments of the base 120, 120¹, 120² comprises a ring-shaped portion 121 provided with a closing portion 122, for example one or more radial protrusions (see the first and second embodiments, especially FIGS. 2 and 6), in order to close off the radial openings 134 in the central portion 133 of the second valve 130.

Referring to the first embodiment, when, in operation, the liquid dosing dispenser 100 is not in a fully compressed position, a generally ring-shaped compression space 192 may be formed in the closure 190, axially outward from the intermediate portion 132 of the second valve 130. Liquid may be drawn from the internal space 180 or the outer space 182 into this compression space 192. This liquid may obstruct operation of the closure 190. Therefore, in certain embodiments, such as the second embodiment, the second valve 130 is provided with at least one hole 137 (cf. FIG. 9). This may be, for example, a number of radially equidistant holes such as the round holes visible in for example FIGS. 9 and 10. These roles may be in a portion of the second valve 130 which is adjacent to the internal space 180, for example in its radially outward portion 131 or intermediate portion 132, in order to allow any such liquid to leave the compression space 192 during a downward stroke.

In certain embodiments, for example in the first and second embodiments, the base of the closure 190 comprises an approximately ring-shaped axially inwardly extending projection 123 disposed in the compression space 192, whose shape corresponds to that of the axially outward side of the intermediate portion 132 of the second valve 130, to support the intermediate portion 132 during at least part of an operational cycle. In other embodiments, depending on the configuration and material properties of the valve, this may not be required (see the third embodiment).

### Resilient Element

As mentioned earlier, the base 120 may be configured to transfer a force from the dispensing unit 110 via the second valve 130, 130¹, 130² to the resilient element 140. For more detail on this resilient element 140, particular reference is made to FIG. 16. In the shown embodiment the resilient element 140 is a spring element, preferably a compression spring element, more preferably a coil spring element or the like. Preferably, the resilient element 140 consists of a single spring element. The resilient element 140 is arranged in the internal space 180, following the contour of the inner surface of the wall of the housing 150. The resilient element 140 is located between the first and second opening and is configured to be compressed in an axial direction by an external force exerted by the base 120 of the closure 190 and to automatically extend in absence of a (sufficiently large) force.

In certain embodiments, depending on the dimensions of the various components, the closure 190 may need to be provided with an additional resilient element 191 (not depicted), preferably a spring made of a same material as other components, positioned in a compression space 192 of the closure, between the base 120 and second valve 130. This additional resilient element 191 applies an axial counterforce to move and/or deform the second valve 130 back to its resting position relative to the base 120 during an upward stroke. This counterforce may be smaller than the force applied by the resilient element 140 and/or the liquid pressure which serve to move and/or deform the second valve 130 during a downward stroke. Alternatively or additionally, this counterforce may be generated by the flexible part(s) of the second valve 130, 130¹, 130² itself.

The resilient element 140 may be embodied in a variety of ways. For example, the resilient element 140 may comprise one or more windings running from one axial end to the other, or it may comprise circumferentially alternating axially diagonal portions 142 which meet in nodes 143 in a circumferentially alternating pattern, as depicted for example FIG. 16. A resilient element 140 according to the latter example may provide a stronger force using a resilient element 140 which fits in the same size of internal space 180.

The resilient element 140 is arranged between the closure 190 and the opposite end (e.g. the bottom) of the housing 150. The housing 150 may optionally comprise a supporting portion 154 configured to guide the shape of the resilient element 140 and/or to controllably receive forces from it. Preferably the supporting portion 154 is an axially outwardly extending ring, extending substantially radially around the internal space 180, along the inner walls of the housing 150.

The resilient element 140 radially surrounds the first valve 160 and functions as a valve seat, keeping the first valve 160 in the same general position over the first opening 151. The first valve 160 may be connected to the resilient element 140, for example fixedly connected. The first valve 160 may be embodied as a single component with the resilient element 140, preferably a single injection molded element. Connecting the first valve 160 and the resilient element 140 and optionally embodying these components as a single component is advantageous in manufacturing and assembly, and in the transmission of forces between the first valve 160 and the resilient element 140.

The resilient element 140 may further be configured so that compression causes the resilient element 140 to buckle slightly radially. This has the effect of applying a (small) force on the first valve 160. This force may compress and/or move the first valve 160 to better close the first opening 151, for example by moving the first valve 160 at least partially into a pipe 153 extending from the housing 150 at the first opening 151. Furthermore, the resilient element 140 and first valve 160 may be configured such that when the resilient element 140 extends, it pulls on the first valve 160, deforming and/or moving the first valve 160 out of and/or away from the first opening 151.

The first valve 160 and the resilient element 140 may be connected via a number of extensions 161, for example three connecting rods 161, in a plurality of locations distributed substantially around the entire edge of the first opening 151 (see the third embodiment, in particular FIG. 16), or may be connected via such extensions 161 in one or more locations distributed over only a portion of the edge of the first opening 151, for example over a single half of the edge of the first opening 151 (see the second embodiment, for example FIG. 6). The latter configuration has the property that the first valve 160 will deform and/or move more easily to allow liquid flow from the container 200 into the internal space 180 when the dispenser moves toward the resting state, because the first valve 160 will open in a skewed or curved manner, for example as depicted in FIG. 4D. This may be advantageous in certain configurations and applications, for example with more viscous liquids.

### Dispensing Unit

As mentioned above, the liquid dosing dispenser 100 further comprises a dispensing unit 110. The dispensing unit 110 may comprise an actuating surface 114 which is configured to receive an axial force (in the shown configuration a depressing force), for instance caused by user pushing on the dispensing unit 110. This actuating surface 114 is preferably located at a radial center of the dispenser 100, to equally distribute a received force. As depicted, the actuating surface 114 is configured to be actuated by a human hand, but alternatively the actuating surface 114 may be configured to receive an actuating force from some other source acting as a user, for example a different body part or a device. The dispensing unit 110 is arranged to contact the base 120, 120¹, 120² of the closure 190, so as to transfer the applied actuating force to the base.

The dispensing unit 110 may comprise a liquid flow passage 113, extending from a first opening 111 near the closure 190 to a dispensing outlet 112 leading to the environment, so as to extend an effective liquid flow passage from the internal space 180 to the environment. The first opening 111 may be located at the radial center of the liquid dosing dispenser 100 below the actuating surface 114 and the dispensing outlet 112 may be located at a radially outward position and/or may face in an essentially arbitrary direction, for example toward a radially outward side or away from the actuating surface 114, to avoid contamination of the actuating surface 114 and/or to fit other requirements of the operating context.

For more detail about a specific embodiment of a dispensing unit 110, particular reference is made to FIG. 6. The dispensing unit 110 may comprise a relative wide inner portion 115, a relative thin intermediate portion 116, and an again relatively wide outer portion 117. The intermediate portion 116 may comprise the fluid flow passage 113 and may extend through a passage inside a housing cover 170, if any. The inner portion 115 may end in a contact surface 118 with the base 120 of the closure 190. The outer portion 117 may end in the actuating surface 114. Such a shape may be advantageous in retaining the dispensing unit 110 inside the housing 150.

The dispensing unit 110 may comprise either one component (see the first embodiment) or multiple components which are attached together, preferably fixedly attached, (see the second and third embodiments) to form the dispensing unit 110. At least one of the portions comprising the dispensing unit 110 may be fixedly attached to, or even manufactured as a single component with (not depicted), the base 120 of the closure 190. For assembling the dispenser 100, it is advantageous if the dispensing unit 100 comprises at least two components 1191, 1192, wherein at least one axially inward component 1191, comprising the axially inward portion 115 and a part of the intermediate portion 116, is added to the liquid dosing dispenser 100 first, then a housing cover 170 is added to the dispenser 100, and then at least one axially outward component 1192, comprising a part of the intermediate portion 116 and the axially outward portion 117, is added. In this case, the part of the intermediate portion 116 of the axially inward component 1191 may comprise a part of a fluid passage 113, and the part of the intermediate portion 116 of the axially outward component 1192 may comprise another, wider part of the fluid passage 113 which fits tightly over the former part.

The liquid dosing dispenser 100 comprises a limited number of components, for example four, five or six components, which has the advantage of simplifying assembly, as well as disassembly should this be required. The limitation of the number of components of the liquid dosing dispenser 100 may be combined with providing good functionality by the feature that individual components each fulfill multiple functions. Some examples are as follows, referring to components discussed above.

The dispensing unit 110 may provide an actuating surface 114 for operating the liquid dosing dispenser 100 and may provide a liquid flow passage 113 toward the environment. The base 130 may close the second opening 152 in an airtight manner and may move to open and close the second opening 152. The second valve 120 may provide a counterpart against which the second valve 130 may close and may sit tightly against second valve 130 and the housing 110 to keep the components of the liquid dosing dispenser 100 together. The resilient element 140 may provide a backstroke force on the closure 190 and may provide a force on the first valve 160 to aid in closing the first opening 151. The resilient element 140 and the first valve 160 may be embodied together as a single component. The first valve 160 may prevent liquid flowing back from the internal space 180 into the container 200 in a resting state and may contribute to achieving a high pressure in the internal space 180 in the compressed state.

Further operation of the liquid dosing dispenser 100 will now be described with reference to the first embodiment. FIGS. 4A-4D depict perspective views of configurations of the first embodiment of a liquid dosing dispenser 100 during an upstroke and downstroke which together comprise an operation cycle. It is noted that the housing 150 and the housing cover 170 do not move or deform during the operational cycle, so a description of these parts will generally be left out below.

In order to describe the operation cycle of the dispenser 100, a number of spaces may be distinguished in and around the dispenser 100. Reference is made to FIG. 2 in particular. An inner space 181 outside the first opening 151 may connect to a container 200 or may be part of a container 200. An internal space 180 is present inside the housing 150. An outer space 182 is delimited by the closure 190 and the dispensing unit 110, optionally being located partially radially between the walls of the housing 150 and next to the environment at the dispensing outlet 112 of the dispensing unit 110.

Furthermore, a number of steps may be distinguished in the liquid flow through the dispenser 100. Referring to FIGS. 1A and 1B, generally, liquid flow is in an axial direction along an imaginary axis IA between the first opening 151 and the second opening 152 of the housing 150. In detail, in a first step, liquid starts in the container 200 and flows from the inner space 181 past the first valve 160 in the first opening 151 into the internal space 180, in first direction Di. In a second step, liquid flows from the internal space 180 past the closure 190 in the second opening 152 into the outer space 182, in second direction Dii. In a third step, liquid flows from the outer space 182 via the liquid flow passage 113 of the dispensing unit 110 into the environment, in third direction Diii.

The liquid dosing dispenser 100 may be configured such that an individual bit of liquid may take either zero, one, or multiple of these steps during an upstroke or downstroke of an operation cycle and may accordingly take either one or multiple operation cycles to flow through the entirety of the dispenser 100.

FIG. 4A depicts a resting state of the first embodiment of the dispenser 100. In the depicted resting state, the liquid dosing dispenser 100 is uncompressed and maximally extended along the imaginary axis AI, its extension being limited by the housing 150 and the housing cover 170. The first valve 160 is located just inside the internal space 180, optionally covering the first opening 151 to prevent liquid flow against the first direction Di which might otherwise occur, for example under the influence of gravity, in certain orientations.

The closure 190 is in an uncompressed state wherein the second valve 130 and the base 120 are spaced maximally apart in an axial direction, such that the one or more holes 134 of the second valve 130 are closed by the one or more closing portions 122 of the base 120. In this way, liquid flow through the second opening 152 in the second direction Dii and/or against the second direction Dii is prevented.

The resilient element 140 is maximally extended, resting against the closure 190 on its axially outward side, effectively resting against the base 120 through the first valve element 130, and resting against a supporting portion 154 of the housing 150 on its axially inward side. The dispensing unit 110 rests against the base 120, for example via respective corresponding ring-shaped surfaces.

The internal space 180 contains a volume of liquid, preferably being substantially full of liquid. In the inner space 181, liquid typically abuts the first opening 151. In the outer space 182, some amount of liquid remains.

FIG. 4B depicts a downward stroke of the first embodiment of the dispenser 100. During the depicted downward stroke, the liquid dosing dispenser 100 is being progressively more compressed in an axial direction, as follows.

An actuating force is applied to the dispensing unit 110 via the actuating surface 114. The dispensing unit 110 is pushed against the axially outward side of the base 120 of the closure 190. The closure 190 is thereby pushed axially inward, and as it moves axially inward, it is resisted by the resilient element 140. This causes the base 120 to be pushed against the second valve 130 at their radially outward portions. The resilient element 140 is being progressively compressed. The resulting decrease in size of the internal space 180 increases the pressure inside the internal space 180, which urges liquid to flow toward the second opening 152 in the second direction Dii. The resulting liquid pressure pushes the central portion 133 of the second valve 130 to move axially outward relative to the base 120. In certain cases, the central portion 133 may even be moved axially outward in an absolute sense, for example in case the internal space 180 is completely filled with an incompressible liquid.

During this axially outward movement, the second valve 130 is subject to elastic deformation, so that its intermediate portion 132 curves or buckles. In certain embodiments, the elastic deformation of the second valve 130 generates an additional force which is mainly generated by the radially outward portion 131 and intermediate portion 132 and acts on the central portion 133, which force contributes to the axially outward movement of the central portion 133. As a result of the axially outward movement, the one or more holes 134 of the second valve 130 are moved axially outside the one or more closing portions 122 of the base 120, to open the closure 190.

The resilient element 140 is being progressively compressed, being pushed on by the closure 190 on its axially outward side, by the base 120 through the first valve element 130 and resting against a supporting portion 154 of the housing 150 on its axially inward side. The resilient element 140 may be slightly deformed at its axially inward side to apply a radially inward force on the first valve 160.

The first valve 160 may receive pressure from liquid inside the internal space 180 and may additionally or alternatively receive a force from the compressing resilient element 140. As a result, the first valve 160 progressively deforms and/or moves to close the first opening 181 and is optionally being progressively deformed and/or moved at least partially into the first opening 181, to close the first opening to prevent liquid flow against the first direction Di which would otherwise be caused primarily by the heightened liquid pressure inside the internal space 180.

In the outer space 182, liquid flows in the third direction Diii toward the environment. The amount of liquid in the internal space 180 progressively decreases.

FIG. 4C depicts a compressed state of the first embodiment of the dispenser 100. In the depicted compressed state, the liquid dosing dispenser 100 is maximally axially compressed, but alternatively a user may end the downstroke before maximal compression is achieved. The first valve 160 is located on the first opening, optionally deformed and/or moved at least partially inside the first opening, to close the first opening to prevent liquid flow against the first direction Di which might otherwise occur under the influence of for example gravity in certain orientations.

The dispensing unit 110 is being pushed against the axially outward side of the base 120. The closure 190 is in a compressed state wherein the second valve 130 and the base 120 are pressed together in an axial direction, such that the one or more holes 134 of the second valve 130 are located axially outside the one or more closing portions 122 of the base 120. The closure 190 is still open, but no substantial liquid flow through the second opening 152 occurs anymore.

The resilient element 140 is substantially maximally compressed, being pushed against by the closure 190 on its axially outward side via the base 120 and the first valve element 130 and resting against a supporting portion 154 of the housing 150 on its axially inward side.

The internal space 180 contains a volume of liquid, typically being substantially precisely full of liquid at the present pressure level, that is, no empty space exists and no more liquid is compelled to flow outwardly. In the inner space 181, liquid typically abuts the first opening 151, optionally applying a slight pressure to the first valve 160. In the outer space 182, some amount of liquid remains, being typically substantially the same amount as in the resting state.

FIG. 4D depicts an upward stroke of the first embodiment of the dispenser 100. During the depicted downward stroke, the liquid dosing dispenser 100 progressively decompresses, regaining a resting state.

The dispensing unit 110 receives less or no actuating force. The resilient element 140 progressively decompresses, applying a force on the closure 190 on its axially outward side, by the base 120 through the first valve element 130, and resting against a supporting portion 154 of the housing 150 on its axially inward side. The resilient element 140 will decrease the radially inward force applied on the first valve 160, if any.

The central portion 133 of the second valve 130 moves axially inward relative to the base 120, so that the one or more holes 134 of the second valve 130 are moved opposite the one or more closing portions 122 of the base 120, to be closed by the one or more closing portions 122 so that liquid flow in the second direction Dii is not possible anymore. During this axially inward movement, the second valve 130 is subject to elastic deformation, so that it returns to its original shape.

The resulting increase in size of the internal space 180 decreases the pressure inside the internal space 180, which causes liquid to flow from the inner space 181 through the first opening 151 in the first direction Di into the internal space 180. This is allowed by the first valve 160, which moves out of the first opening 151 if applicable and moves radially outward as a result of the pressure of the liquid flow. This radially outward movement may be substantially equal on all circumferential sides of the first valve 160 or the first valve 160 may open in a skewed or curved manner, for example only on one circumferential side.

The amount of liquid in the internal space 180 progressively increases. In the inner space 181, liquid moves toward the first opening 151. In the outer space 182, no liquid flow occurs. The dispensing unit 110 progressively moves radially outward as a result of the force from the axially outward side of the closure 190.

Next, the liquid flow through the liquid dosing dispenser 100 during an operational cycle will be described in further detail.

When the liquid dosing dispenser 100 is first applied to a container 200, the liquid dosing dispenser 100 may be substantially empty of liquid, being empty of all fluids other than an environmental fluid such as air. In order to prepare the liquid dosing dispenser 100 for effective operation, a number of actuating strokes on the dispensing unit 110 may be required to draw an initial volume of liquid into the internal space 180 and optionally into the inner space 181 and/or outer space 182 of the dispenser 100.

The liquid dosing dispenser 100 is configured such that all dispensed doses have the same size.

During an upstroke, a volume of liquid equal to a single dose will move from the inner space 181 into the internal space 180 in direction Di. A dose is smaller than the volume of the internal space 180 in the resting state, being equal to the difference between the volume of the internal space 180 in the resting state and the volume of the internal space 180 in the compressed state.

During a downstroke, a volume of liquid equal to a single dose will move out of the internal space 180 in direction Dii, and a volume of liquid equal to a single dose will be dispensed to the environment in direction Diii. In the resting state, a volume of liquid remains in the outer space 182. A dose may be larger or smaller than this remaining volume. Depending on the relative volume of the outer space 182 and a single dose, an individual bit of liquid may take multiple cycles of operation to move through the outer space 182.

An individual bit of liquid may take multiple cycles of operation to move through the dispenser 100. For example, an individual bit of liquid may take two and a half cycles of operation to move through the dispenser, by moving from the inner space 181 to the internal space 180 during an upstroke, then moving from the internal space 180 to the outer space 182 in direction Dii during the subsequent downstroke and moving from the outer space 182 to the environment in direction Diii during another downstroke.

Alternatively, some individual bits of liquid will move from the internal space 180 through the outer space 182 to the environment during only a single downstroke.

A dispenser 100 according to the disclosure allows substantially no liquid flow in the opposite general direction, that is, opposite to directions Di, Dii, and/or Diii. This has the advantage of preventing contamination of the liquid which resides in the liquid dosing dispenser 100 or in the container 200 with substances from the environment.

FIG. 17 depicts an embodiment of a container 200 provided with a liquid dosing dispenser 100. In the depicted embodiment, the container 200 is a bottle.

The container 200 and the liquid dosing dispenser 100 may be fixedly connected to each other, or may be removable attached, for example via threaded fastening using respective screw threads. The liquid dosing dispenser 100 may even sit unfastened in or on the container 200, as long as a connection is formed between the first opening 151 and the liquid in the container 200, so that liquid may be drawn into the dispenser 100.

It is to be understood that this disclosure is not limited to particular aspects described, and, as such, may vary. It is also to be understood that the terminology used herein is for the purpose of describing particular aspects only, and is not intended to be limiting, since the scope of the present disclosure will be limited only by the appended claims.

1. A liquid dosing dispenser, comprising:
a housing defining an internal space comprising a first opening and a second opening, wherein the housing is configured to be attached to a container, such that a first liquid flow passage is formed from the container through the first opening into the internal space;
a dispensing unit configured to be attached to or form an integral part with the housing, such that a second liquid flow passage is formed from the internal space of the housing through the second opening to a dispensing outlet located outside the housing;
a first valve arranged in the internal space and configured to selectively close and open the first opening;
a closure arranged in the internal space between the first valve and the dispensing unit, the closure being configured to selectively close and open a third liquid flow passage extending from the first liquid flow passage to the second liquid flow passage, the closure comprising a second valve and a base, wherein at least one of the base and the second valve are movable in axial direction between a resting position and a compressed position;
a compressible resilient element arranged in the internal space between the first valve and the second valve of the closure and configured to urge the at least one of the base and the second valve from the compressed position to the resting position;
wherein the dispensing unit is configured to move the at least one of the base and the second valve from the resting position to the compressed position upon application of an external actuating force on the dispensing unit; and
wherein the second valve of the closure is further configured to be movable with respect to the base, to open the third liquid flow passage when the at least one of the base and the second valve is moved by the dispensing unit from the resting position to the compressed position and/or to close the third liquid flow passage when the at least one of the base and the second valve of the closure is moved by the compressible resilient element from the compressed position to the resting position.

2. The dosing dispenser of claim 1, wherein:
the first valve is configured to close the first opening when the second valve is moved to the resting position and to open the first opening when the second valve is moved to the compressed position, and/or
the first valve is a one-way valve.

3. (canceled)

4. The dosing dispenser of claim 1, as claimed in claim 1, further configured to increase a pressure in the internal space of the housing by having the dispensing unit move the base and at least a part of the second valve in axial direction from the resting position towards the compressed position thereby compressing the compressible resilient element and/or to reduce the pressure in the internal space of the housing by having the compressed resilient element move the base and at least a part of the second valve in axial direction from the compressed position towards the resting position.

5. (canceled)

6. The dosing dispenser of claim 1, wherein opening the third liquid flow passage between the first liquid flow passage and second liquid flow passage comprises allowing a pressure increase in the internal space resulting from a movement of the closure from the resting position to the compressed position to move a central portion of the second valve relative to the base from a closed to an open position.

7. The dosing dispenser of claim 1, wherein closing the third liquid flow passage between the first liquid flow passage and second liquid flow passage comprises allowing a pressure decrease in the internal space resulting from a movement of the closure from the compressed position to the resting position to move a central portion of the second valve relative to the base from an open position to a closed position.

8. The dosing dispenser of claim 1, wherein the direction of a relative movement of a central portion from the closed position to the open position is opposite the direction of the movement of the base from the resting position to the compressed position, and/or
wherein the direction of the relative movement of a central portion from the open position to the closed position is opposite the direction of the movement of the base from the compressed position to the resting position.

9. The dosing dispenser of claim 1, which is further configured such that when an actuating force is applied to the dispensing unit:
the dispensing unit transfers the actuating force to the resilient element via the closure, to compress the resilient element;
a size of the internal space is decreased, increasing a liquid pressure inside the housing;
the first valve closes the first opening; and
the second valve moves axially outward relative to the base and/or deforms, such that the closure stops closing the second opening.

10. The dosing dispenser of claim 1, which is further configured such that when an actuating force on the dispensing unit is removed or reduced in the compressed position:
the dispenser performs an upstroke into the resting position; and
a pressure is decreased inside the housing to draw liquid from the container through the first opening into the internal space.

11. (canceled)

12. The dosing dispenser of claim 1, further comprises a ring-shaped housing cover arranged over the radial outside of the second opening, to prevent the closure and the resilient element from exiting the internal space.

13. The Liquid dosing dispenser of claim 1, wherein in both the resting position and the compressed position, the internal space has a respective predetermined size, to displace a predetermined liquid dose when moving to the compressed position.

14. The dosing dispenser of claim 1, wherein the first valve comprises a thin flexible sheet, which is configured to deform and/or to at least partially move into the first opening to close the first opening.

15. The dosing dispenser of claim 1, wherein the first valve is mounted to or integrally formed with the compressible resilient element.

16. The dosing dispenser of claim 1, wherein:
the first valve and the resilient element are connected in a plurality of locations distributed around an edge of the first opening, or
the first valve and the resilient element are connected at one or more locations distributed over a single half of the edge of the first opening.

17. (canceled)

18. The dosing dispenser of claim 1, wherein the housing, the resilient element, the first valve, the closure, and the dispensing unit comprise a single material.

19. (canceled)

20. The dosing dispenser of claim 1, wherein the second valve is provided with at least one additional hole in a portion adjacent to the internal space, in order to allow liquid to leave an internal compression space of the closure between the base and second valve during a downstroke.

21. The dosing dispenser of claim 1, wherein a central portion of the second valve extends in axial direction towards the dispensing unit, the central portion essentially having a cylindrical shape and/or the central portion comprising a plurality of radially arranged holes,
wherein the plurality of radially arranged holes are configured to be positioned corresponding to associated closing portions of the base to close the holes when the central portion is in the closed position and the closure is in the resting position;
wherein the plurality of radially arranged holes are configured to be axially outside the corresponding closing portions of the base to open the holes when the central portion is in the open position and the closure is in the compressed position.

22. The dosing dispenser of claim 1, wherein the closure is provided with an additional resilient element, positioned in a compression space of the closure between the base and second valve.

23. The dosing dispenser of claim 1, wherein the second valve is configured to deform and regain a resting shape during a movement from the compressed position to the resting position.

24. The dosing dispenser of claim 1,
wherein the resilient element extends around the internal space, along inner walls of the housing, and/or
wherein the resilient element comprises a spring.

25-27. (canceled)

28. A method of operating the liquid dosing dispenser of claim 1: the method comprising
dispensing a predetermined dose of liquid by increasing a pressure in the internal space of the housing by having the dispensing unit move the base and at least a part of the second valve in axial direction from the resting position towards the compressed position thereby compressing the compressible resilient element and/or comprising filling the housing with a predetermined dose of liquid by reducing the pressure in the internal space of the housing by having the compressed resilient element move the base and at least a part of the second valve in axial direction from the compressed position towards the resting position.
